(19) United States
(12) Patent Application Publication
(10) Pub. No.: US 2026/0299368 A1
(43) Pub. Date: Oct. 1, 2026

(54) PIXEL STRUCTURE

(71) Applicant: E Ink Holdings Inc., Hsinchu (TW)

(72) Inventors: Wen Che Wang, Hsinchu (TW); Kuang-Heng Liang, Hsinchu (TW)

(73) Assignee: E Ink Holdings Inc., Hsinchu (TW)

(21) Appl. No.: 19/439,437

(22) Filed: Jan. 4, 2026

(30) Foreign Application Priority Data
Mar. 26, 2025 (TW) 114111416

(51) Int. Cl. G02F 1/16766; G02F 1/167

(52) U.S. Cl. CPC G02F 1/16766; G02F 1/167

(57) ABSTRACT

A pixel structure includes a first sub-pixel unit, a second sub-pixel unit, and a third sub-pixel unit. The first sub-pixel unit is configured to correspond to a first region of a display layer of a display device, where the first region of the display layer has a first display area. The second sub-pixel unit is configured to correspond to a second region of the display layer, where the second region of the display layer has a second display area. The third sub-pixel unit is configured to correspond to a third region of the display layer, where the third region of the display layer has a third display area. An area ratio of the first sub-pixel unit, the second sub-pixel unit, and the third sub-pixel unit is substantially the same as an area ratio of the first display area: the second display area: the third display area.

### CROSS-REFERENCE TO RELATED APPLICATION

This application claims the priority benefit of Taiwan application serial no. 114111416, filed on Mar. 26, 2025. The entirety of each of the above-mentioned patent application is hereby incorporated by reference herein and made a part of this specification.

### BACKGROUND

### Technical Field

The disclosure relates to a display device, and particularly relates to a pixel structure of a display device.

### Description of Related Art

In recent years, e-ink displays have gradually gained attention, and with technological advancements, e-ink displays capable of displaying color patterns have been developed. Generally, e-ink displays utilize a pixel array substrate to drive ink particles encapsulated in the display layer to produce black and white patterns, and may display color patterns by setting up color layers (such as red, blue, green layers) above the display layer. In order to optimize the color gamut, contrast, gradation, etc. of the displayed colors, the area ratio between different color layers is usually adjusted to optimize optical properties. However, as the area of the color layers is adjusted, the corresponding pixel units on the pixel array substrate below have not been adjusted accordingly, resulting in a decrease in the display quality of the display and affecting the viewing experience. Therefore, how to improve the display quality is a problem that currently needs to be addressed.

### SUMMARY

The disclosure provides a pixel structure, which may enhance the display quality of the display device.

A pixel structure of the disclosure includes a first sub-pixel unit, a second sub-pixel unit, and a third sub-pixel unit. The first sub-pixel unit is configured to correspond to a first region of a display layer of a display device, where the first region of the display layer has a first display area. The second sub-pixel unit is configured to correspond to a second region of the display layer, where the second region of the display layer has a second display area. The third sub-pixel unit is configured to correspond to a third region of the display layer, where the third region of the display layer has a third display area. An area ratio of the first sub-pixel unit, the second sub-pixel unit, and the third sub-pixel unit is substantially the same as an area ratio of the first display area: the second display area: the third display area.

In an embodiment of the disclosure, a storage capacitance of the first sub-pixel unit, a storage capacitance of the second sub-pixel unit, and a storage capacitance of the third sub-pixel unit are substantially the same.

In an embodiment of the disclosure, each of the first sub-pixel unit, the second sub-pixel unit, and the third sub-pixel unit includes a pixel electrode, an auxiliary electrode, and a first common electrode. The auxiliary electrode is electrically connected to the pixel electrode. The first common electrode is located between the auxiliary electrode and the pixel electrode.

In an embodiment of the disclosure, an area ratio of the pixel electrode of the first sub-pixel unit, the pixel electrode of the second sub-pixel unit, and the pixel electrode of the third sub-pixel unit is substantially the same as an area ratio of the first display area: the second display area: the third display area.

In an embodiment of the disclosure, each of the first sub-pixel unit, the second sub-pixel unit, and the third sub-pixel unit further includes a second common electrode, which is electrically connected to the first common electrode. In the first sub-pixel unit, a total of an overlap area between the first common electrode and the pixel electrode and an overlap area between the second common electrode and the auxiliary electrode has a first value. In the second sub-pixel unit, a total of an overlap area between the first common electrode and the pixel electrode and an overlap area between the second common electrode and the auxiliary electrode has a second value. In the third sub-pixel unit, a total of an overlap area between the first common electrode and the pixel electrode and an overlap area between the second common electrode and the auxiliary electrode has a third value. The first value, the second value, and the third value are substantially the same.

In an embodiment of the disclosure, the first common electrode extends along edges of at least two sides of the pixel electrode.

In an embodiment of the disclosure, a shape of the first common electrode includes a rectangular shape with a notch, an inverted U shape, a U shape, a rectangular ring shape, or an H shape.

In an embodiment of the disclosure, the first common electrode of the one with the largest area among the first sub-pixel unit, the second sub-pixel unit, and the third sub-pixel unit does not overlap with the auxiliary electrode.

In an embodiment of the disclosure, the pixel structure further includes a first data line, which is located at one side of the first sub-pixel unit, where a nearest distance between the first common electrode of the first sub-pixel unit and the first data line is not less than a nearest distance between the pixel electrode of the first sub-pixel unit and the first data line.

In an embodiment of the disclosure, the pixel structure further includes a second data line, which is located between the first sub-pixel unit and the second sub-pixel unit. A coupling capacitance between the pixel electrode of the first sub-pixel unit and the first data line, a coupling capacitance between the pixel electrode of the first sub-pixel unit and the second data line, and a coupling capacitance between the pixel electrode of the second sub-pixel unit and the second data line are approximate to each other.

Based on the above, the pixel structure of the disclosure includes a first sub-pixel unit, a second sub-pixel unit, and a third sub-pixel unit corresponding to the first region, the second region, and the third region of the display layer of the display device, and the area ratio of the first sub-pixel unit, the second sub-pixel unit, and the third sub-pixel unit is substantially the same as the area ratio of the first region, the second region, and the third region. Therefore, it may improve the image quality of the display device. In addition, the storage capacitance of the first sub-pixel unit, the second sub-pixel unit, and the third sub-pixel unit are approximately the same, which may enhance the display quality of the display device.

### BRIEF DESCRIPTION OF THE DRAWINGS

FIG. 1 is a schematic exploded diagram of a display device according to an embodiment of the disclosure.

FIG. 2 is a schematic cross-sectional diagram of a display device according to an embodiment of the disclosure.

FIG. 3 is a layout diagram of a pixel structure according to an embodiment of the disclosure.

FIG. 4A to FIG. 4D are schematic diagrams of a common electrode according to an embodiment of the disclosure.

FIG. 5 is a partially enlarged schematic diagram of FIG. 3.

### DESCRIPTION OF THE EMBODIMENTS

In the drawings, the thickness of layers, films, panels, regions, etc., are exaggerated for clarity's sake. The same reference numerals refer to the same elements throughout the specification. It will be understood that when a component such as a layer, a film, a region, or a substrate is referred to be “on” or “connected to” another component, it may be directly on or connected to the another component, or intermediate components may also exist therebetween. Comparatively, when a component is referred to be “directly on” or “directly connected to” another component, no intermediate component exists therebetween. As used herein, the “connection” may refer to physical and/or electrical connection. Furthermore, “electrical connection” or “coupling” of two components may refer to that other components may exist between the two components.

It should be understood that although the terms “first”, “second,” etc., may be used for describing various elements, components, regions, layers and/or portions, the elements, components, regions, and/or portions are not limited by these terms. These terms are only used for separating one element, component, region, layer or portion from another element, component, region, layer or portion. Therefore, the following discussed “first element”, “component”, “region”, “layer” or “portion” may be referred to as the second element, component, region, layer or portion without departing from the scope of the disclosure.

Considering the discussed measurement and a specific number of errors associated with the measurement (i.e., limitations of the measurement system), the terms “about”, “substantially”, or “approximate” used herein include the related value and an average within an acceptable deviation range for a specific value determined by those skilled in the art. For example, “about” may represent a range within one or a plurality of standard deviations of the related value, or within ±30%, ±20%, ±10%, ±5%. Furthermore, the “about”, “substantially”, or “approximate” used herein may be a more acceptable deviation range or standard deviation based on electrical properties, optical properties, etching properties, or other properties, and not one standard deviation may be applied to all properties.

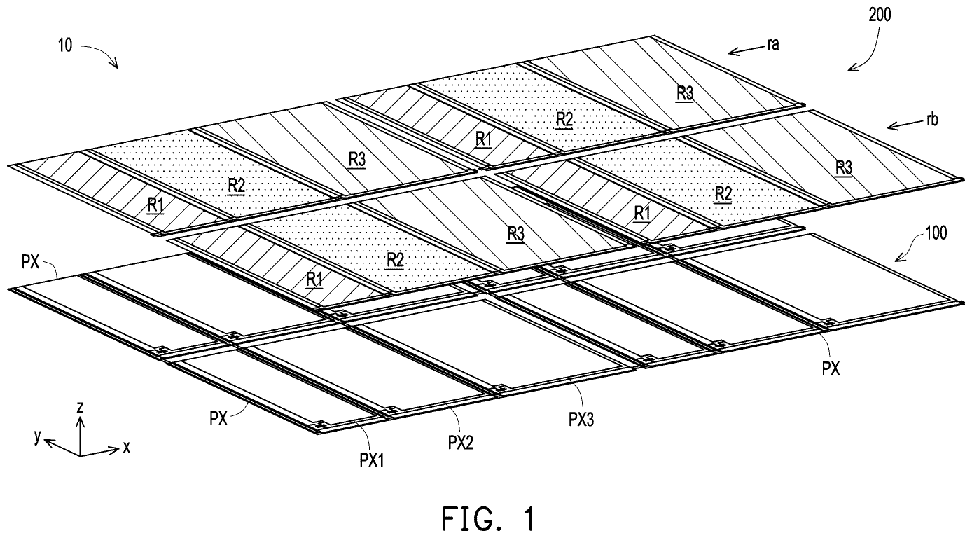

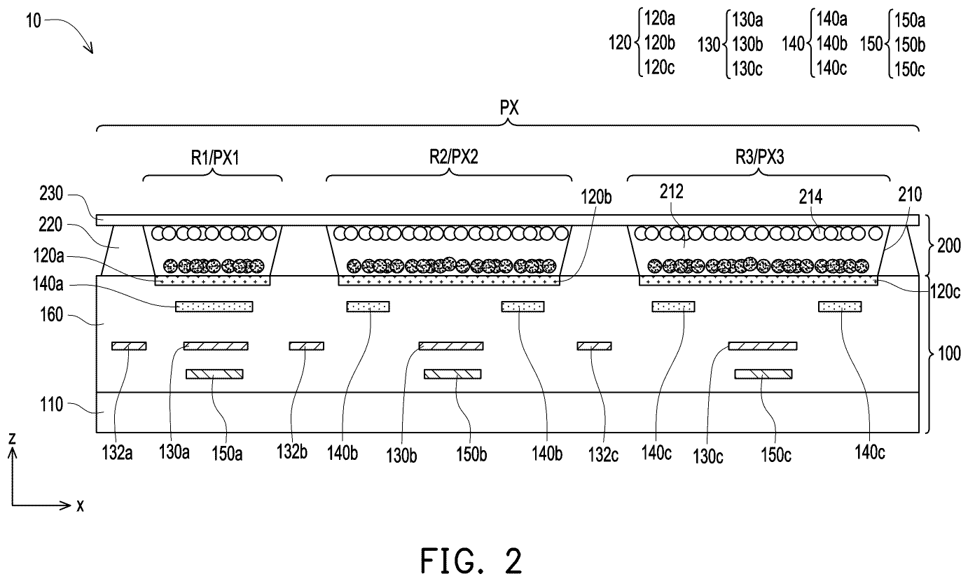

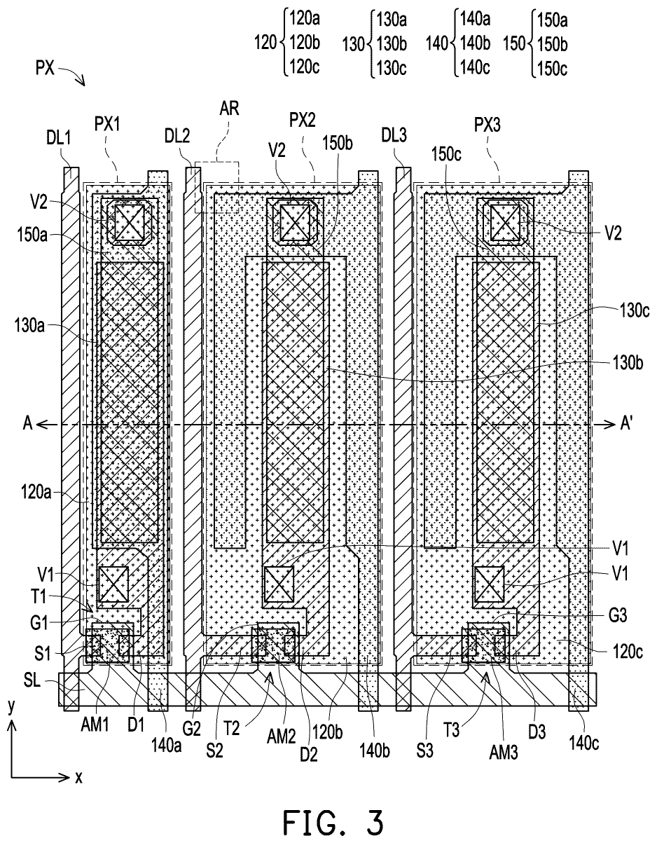

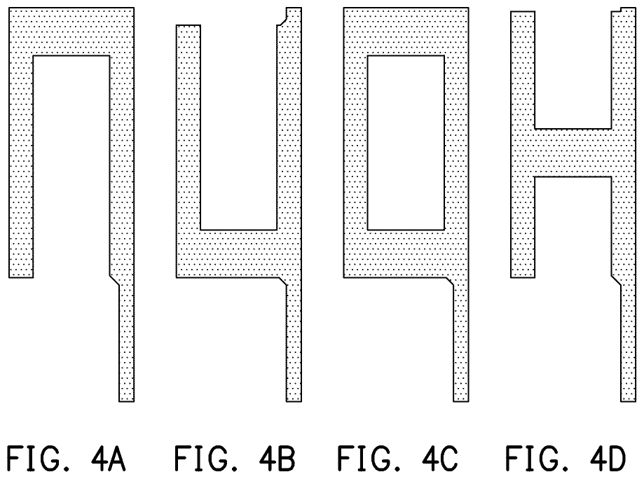

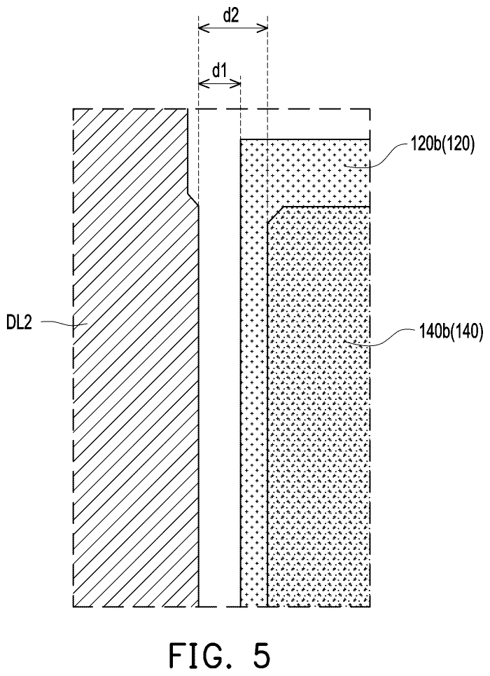

FIG. 1 is a schematic exploded diagram of a display device according to an embodiment of the disclosure. FIG. 2 is a schematic cross-sectional diagram of a display device according to an embodiment of the disclosure. FIG. 3 is a layout diagram of a pixel structure according to an embodiment of the disclosure. FIG. 4A to FIG. 4D are schematic diagrams of a common electrode according to an embodiment of the disclosure. FIG. 5 is a partially enlarged schematic diagram of the region AR of FIG. 3. FIG. 2 may be a schematic cross-sectional diagram cut along the section line A-A′ of FIG. 3. For clarity, the insulation layer 160 and the substrate 110 are omitted in FIG. 3.

Referring to FIG. 1 to FIG. 3, a display device 10 includes a pixel array substrate 100 and a display layer 200. The pixel array substrate 100 includes multiple pixel structures PX disposed on a substrate 110. The display layer 200 is disposed on the pixel array substrate 100. That is, the substrate 110, the pixel structures PX, and the display layer 200 are stacked in the z direction. Therefore, the z direction may also be designated as the stacking direction.

The display layer 200 has a first region R1, a second region R2, and a third region R3. The first region R1, the second region R2, and the third region R3 may display different colors, for example, the first region R1 displays blue, the second region R2 displays red, and the third region R3 displays green. However, the disclosure is not limited thereto. The colors displayed by the first region R1, the second region R2, and the third region R3 may be adjusted according to actual requirements.

In some embodiments, the first region R1, the second region R2, and the third region R3 are arranged sequentially and repeatedly in the x direction to form rows (e.g., rows ra, rb). The display layer 200 may have multiple rows ra, rb constituted by multiple first regions R1, second regions R2, and third regions R3, with the multiple rows ra, rb aligned with each other, such that the first region R1, the second region R2, and the third region R3 of each row (e.g., row ra) are respectively aligned with the first region R1, the second region R2, and the third region R3 of the adjacent row (e.g., row rb). That is, multiple first regions R1 may be arranged in the y direction, multiple second regions R2 may be arranged in the y direction, and multiple third regions R3 may be arranged in the y direction. In some embodiments, the x direction, y direction, and z direction intersect with each other, for example, orthogonally.

In some embodiments, the first region R1 has a first display area, the second region R2 has a second display area, the third region R3 has a third display area, and the color gamut of the display device 10 may be enhanced by adjusting the ratio of the first display area, the second display area, and the third display area. In FIG. 1, it is schematically illustrated that the third display area is greater than the second display area, and the second display area is greater than the first display area, but it is not intended to limit the disclosure. The ratio of the first display area, the second display area, and the third display area does not have a fixed range but is adjusted according to the required optical specifications.

In some embodiments, the display layer 200 may be a component that encapsulates the display medium into a layer. The display medium may include electrophoretic display material or other suitable display materials. The display layer 200 may adopt microcup structures, microcapsule structures, or other methods to encapsulate the display medium, but the disclosure is not limited thereto. For example, in FIG. 2, the display layer 200 may include a display medium layer 210, a microcup structure 220, and a cover layer 230. The display medium layer 210 is disposed in the microcup structure 220 to provide the display layer 200 with the first region R1, the second region R2, and the third region R3. The cover layer 230 covers the display medium layer 210 and the microcup structure 220. In some embodiments, the display medium layer 210 may display black and white or colors, but the disclosure is not limited thereto. In some embodiments, the display medium layer 210 may include an electrophoresis fluid 212 and charged particles 214 distributed in the electrophoresis fluid. The charged particles 214 may include black particles and white particles and/or particles of other colors (e.g., red, yellow, etc.).

In some embodiments, the display device 10 may also include a color filter layer (not illustrated) disposed on the display layer 200. The color filter layer may set different color filters according to the colors to be displayed by the first region R1, the second region R2, and the third region R3 of the display layer.

In some embodiments, the multiple pixel structures PX of the pixel array substrate 100 may be arranged in an array along the x direction and y direction on the substrate 110. In some embodiments, the material of the substrate 110 may include glass, plastic, or other suitable materials, where the plastic may include polyethylene terephthalate (PET), polyimide (PI), polycarbonate (PC), polyacrylate (PA), or other suitable plastic materials. In some embodiments, the substrate 110 may have flexibility.

In some embodiments, the pixel structure PX includes a first sub-pixel unit PX1, a second sub-pixel unit PX2, and a third sub-pixel unit PX3. The first sub-pixel unit PX1 is configured to correspond to the first region R1 of the display layer 200, the second sub-pixel unit PX2 is configured to correspond to the second region R2 of the display layer 200, and the third sub-pixel unit PX3 is configured to correspond to the third region R3 of the display layer 200.

In some embodiments, the pixel structure PX also includes a first data line DL1, a second data line DL2, a third data line DL3, and a scan line SL. The first data line DL1, the second data line DL2, and the third data line DL3 are arranged in the x direction and extend in the y direction, while the scan line SL extends in the x direction. The first data line DL1, the second data line DL2, and the third data line DL3 may be respectively located at one side of the first sub-pixel unit PX1, the second sub-pixel unit PX2, and the third sub-pixel unit PX3. For example, as shown in FIG. 3, the first data line DL1, the second data line DL2, and the third data line DL3 are respectively located at the left side of the first sub-pixel unit PX1, the second sub-pixel unit PX2, and the third sub-pixel unit PX3. The first sub-pixel unit PX1 is located between the first data line DL1 and the second data line DL2, and the second sub-pixel unit PX2 is located between the second data line DL2 and the third data line DL3. The second data line DL2 is located between the first sub-pixel unit PX1 and the second sub-pixel unit PX2, and the third data line DL3 is located between the second sub-pixel unit PX2 and the third sub-pixel unit PX3. In some embodiments, the scan line SL may be located at the lower side of the first sub-pixel unit PX1, the second sub-pixel unit PX2, and the third sub-pixel unit PX3.

In some embodiments, the first sub-pixel unit PX1, the second sub-pixel unit PX2, and the third sub-pixel unit PX3 respectively include an active component T1, an active component T2, and an active component T3. The active components T1, T2, and T3 may, for example, be thin film transistors, which include a gate (e.g., G1, G2, G3), a semiconductor layer (e.g., AM1, AM2, AM3), a source (e.g., S1, S2, S3), and a drain (e.g., D1, D2, D3).

In some embodiments, the source S1 of the active component T1 may be electrically connected to the first data line DL1, the source S2 of the active component T2 may be electrically connected to the second data line DL2, and the source S3 of the active component T3 may be electrically connected to the third data line DL3. The gate G1 of the active component T1, the gate G2 of the active component T2, and the gate G3 of the active component T3 may be electrically connected to the scan line SL.

In some embodiments, the first sub-pixel unit PX1, the second sub-pixel unit PX2, and the third sub-pixel unit PX3 may each include a pixel electrode 120, an auxiliary electrode 130, a first common electrode 140, and a second common electrode 150 disposed in an insulation layer 160, where the insulation layer 160 separates the pixel electrode 120, the auxiliary electrode 130, the first common electrode 140, and the second common electrode 150. The pixel electrode 120, the auxiliary electrode 130, the first common electrode 140, and the second common electrode 150 are respectively located in different film layers, and are stacked from bottom to top in the z direction in the order of the second common electrode 150, the auxiliary electrode 130, the first common electrode 140, and the pixel electrode 120. Therefore, the first common electrode 140 is located between the auxiliary electrode 130 and the pixel electrode 120, and the auxiliary electrode 130 is located between the first common electrode 140 and the second common electrode 150.

In some embodiments, the auxiliary electrode 130 and the first data line DL1, the second data line DL2, and the third data line DL3 are located in the same film layer, but the disclosure is not limited thereto. In some embodiments, the second common electrode 150 and the scan line SL are located in the same film layer, but the disclosure is not limited thereto.

In some embodiments, the auxiliary electrode 130 and the pixel electrode 120 may be electrically connected through a conductive via V1 and have the same potential. In some embodiments, the auxiliary electrode 130 and the pixel electrode 120 may be electrically connected to the drain (e.g., D1, D2, or D3) of the active component (e.g., active component T1, T2, or T3) in their respective sub-pixel units (e.g., the first sub-pixel unit PX1, the second sub-pixel unit PX2, or the third sub-pixel unit PX3).

In some embodiments, the first common electrode 140 and the second common electrode 150 may be electrically connected through a conductive via V2 and have the same potential.

In some embodiments, the first common electrode 140 and the pixel electrode 120 partially overlap in the z direction, the second common electrode 150 and the auxiliary electrode 130 partially overlap in the z direction, so as to form a storage capacitance of the sub-pixel unit (e.g., the first sub-pixel unit PX1, the second sub-pixel unit PX2, and the third sub-pixel unit PX3) between the first common electrode 140 and the pixel electrode 120, and between the second common electrode 150 and the auxiliary electrode 130.

In some embodiments, capacitance may also be generated between the first common electrode 140 and the auxiliary electrode 130, but since the distance between the first common electrode 140 and the auxiliary electrode 130 is greater, the capacitance generated is smaller and may be negligible.

For the convenience of description and understanding, the pixel electrode 120, auxiliary electrode 130, first common electrode 140, and second common electrode 150 of the first sub-pixel unit PX1 are marked as 120a, 130a, 140a, 150a; the pixel electrode 120, auxiliary electrode 130, first common electrode 140, and second common electrode 150 of the second sub-pixel unit PX2 are marked as 120b, 130b, 140b, 150b; and the pixel electrode 120, auxiliary electrode 130, first common electrode 140, and second common electrode 150 of the third sub-pixel unit PX3 are marked as 120c, 130c, 140c, 150c.

In some embodiments, an area ratio of the first sub-pixel unit PX1, the second sub-pixel unit PX2, and the third sub-pixel unit PX3 is substantially the same as an area ratio of the first display area: the second display area: the third display area, or an area ratio of the pixel electrode 120a of the first sub-pixel unit PX1, the pixel electrode 120b of the second sub-pixel unit PX2, and the pixel electrode 120c of the third sub-pixel unit PX3 is substantially the same as an area ratio of the first display area: the second display area: the third display area, thereby enhancing the quality of the displayed image.

In some embodiments, the area of the pixel electrode 120a of the first sub-pixel unit PX1 is substantially the same as the first display area, the area of the pixel electrode 120b of the second sub-pixel unit PX2 is substantially the same as the second display area, and the area of the pixel electrode 120c of the third sub-pixel unit PX3 is substantially the same as the third display area, so as to effectively drive the corresponding regions (i.e., the first region R1, the second region R2, and the third region R3) of the display layer 200, thereby enhancing the quality of the displayed image.

In some embodiments, the storage capacitance of the first sub-pixel unit PX1, the storage capacitance of the second sub-pixel unit PX2, and the storage capacitance of the third sub-pixel unit PX3 are substantially the same, so that sub-pixel units with different area sizes may have similar electrical properties, thereby enhancing the display quality of the display device 10.

In some embodiments, in the first sub-pixel unit PX1, a total of an overlap area between the first common electrode 140a and the pixel electrode 120a and an overlap area between the second common electrode 150a and the auxiliary electrode 130a has a first value. In the second sub-pixel unit PX2, a total of an overlap area between the first common electrode 140b and the pixel electrode 120b and an overlap area between the second common electrode 150b and the auxiliary electrode 130b has a second value. In the third sub-pixel unit PX3, a total of an overlap area between the first common electrode 140c and the pixel electrode 120c and an overlap area between the second common electrode 150c and the auxiliary electrode 130c has a third value. The first value, the second value, and the third value are substantially the same, so that the first sub-pixel unit PX1, the second sub-pixel unit PX2, and the third sub-pixel unit PX3 have substantially the same storage capacitance. Here, the overlap area refers to the area of the overlapping part in the z direction.

In some embodiments, in the case where the overlap area between the second common electrode 150 and the auxiliary electrode 130 is the same in the first sub-pixel unit PX1, the second sub-pixel unit PX2, and the third sub-pixel unit PX3, the overlap area between the first common electrode 140 and the pixel electrode 120 is also the same in the first sub-pixel unit PX1, the second sub-pixel unit PX2, and the third sub-pixel unit PX3.

In some embodiments, the storage capacitance capacity of each sub-pixel unit in the pixel structure PX (including the first sub-pixel unit PX1, the second sub-pixel unit PX2, and the third sub-pixel unit PX3) may be designed based on the sub-pixel unit with the smallest area in the pixel structure PX. In this embodiment, since the area of the first sub-pixel unit PX1 is smaller than the area of the second sub-pixel unit PX2 and the area of the third sub-pixel unit PX3, the design may be based on the first sub-pixel unit PX1.

In some embodiments, the sub-pixel unit with the smallest area (e.g., the first sub-pixel unit PX1) may be designed to satisfy the following equation 1, where it is assumed that the charging rate of the sub-pixel unit with the smallest area is between 70% and 95%.

$$Cst / A * K = 40 ∼ 60 , \qquad ( equation 1 )$$

where Cst is the sub-pixel storage capacitance, in units of picofarads (pF); A is the sub-pixel area, in units of square micrometers (μm²); and K is a constant that may be adjusted according to design requirements, for example K=1000000.
Through the above, the sub-pixel storage capacitance of the sub-pixel unit with the smallest area may be obtained. Then, the remaining sub-pixel units (e.g., the second sub-pixel unit PX2 and the third sub-pixel unit PX3) may be designed based on the obtained sub-pixel storage capacitance to determine the size of the overlap area between the first common electrode 140 and the pixel electrode 120 and/or between the second common electrode 140 and the auxiliary electrode 130.

In some embodiments, in the case where the overlap area between the second common electrode 150 and the auxiliary electrode 130 is fixed in the second sub-pixel unit PX2 and the third sub-pixel unit PX3, the predetermined storage capacitance capacity may be achieved by changing the area of the first common electrode 140.

In some embodiments, the first common electrode 140a of the sub-pixel unit with the smallest area in the pixel structure PX (e.g., the first sub-pixel unit PX1) may overlap with the pixel electrode 120a, the auxiliary electrode 130a, and the second common electrode 150a in the z direction. In some embodiments, the first common electrode 140a does not overlap with the active component T1 in the z direction, such that the shape of the first common electrode 140a is a rectangular with a notch or similar shape.

In some embodiments, for the sub-pixel unit with the largest area in the pixel structure PX (e.g., the third sub-pixel unit PX3) and/or the sub-pixel unit with the second largest area (e.g., the second sub-pixel unit PX2), their first common electrode 140 may extend along the edges of at least two sides of the pixel electrode 120, for example, extending along the two sides of the pixel electrode 120 that are close to the data lines. Specifically, the first common electrode 140b may extend along the side of the pixel electrode 120b that is close to the second data line DL2 and the side of the pixel electrode 120b that is close to the third data line DL3, and the first common electrode 140c may extend along the side of the pixel electrode 120c that is close to the third data line DL3 and the side that is close to the first data line DL1 of the adjacent pixel structure PX. In this way, the first common electrodes 140b, 140c may provide a shielding effect, reducing the coupling capacitance between the pixel electrodes 120b, 120c and the data lines DL2, DL3, thereby matching the coupling capacitance between the sub-pixel unit with the smallest area (e.g., the first sub-pixel unit PX1) and its adjacent data line (e.g., the first data line DL1 or the second data line DL2).

In other words, in this embodiment, the coupling capacitance between the pixel electrode 120a of the first sub-pixel unit PX1 and the first data line DL1, the coupling capacitance between the pixel electrode 120a of the first sub-pixel unit PX1 and the second data line DL2, the coupling capacitance between the pixel electrode 120b of the second sub-pixel unit PX2 and the second data line DL2, the coupling capacitance between the pixel electrode 120b of the second sub-pixel unit PX2 and the third data line DL3, the coupling capacitance between the pixel electrode 120c of the third sub-pixel unit PX3 and the third data line DL3, and the coupling capacitance between the pixel electrode 120c of the third sub-pixel unit PX3 and the first data line DL1 of the adjacent pixel structure PX may be approximate to each other, thereby reducing the possibility of cross talk and enhancing the display quality of the display device 10. Here, “coupling capacitance approximate to each other” means that the difference between two coupling capacitances is within the range of 10% to 15% or below.

In some embodiments, for the sub-pixel unit with the largest area in the pixel structure PX (e.g., the third sub-pixel unit PX3) and/or the sub-pixel unit with the second largest area (e.g., the second sub-pixel unit PX2), their auxiliary electrode 130c (and/or auxiliary electrode 130b) overlaps with the second common electrode 150c (and/or the second common electrode 150b) in the z direction, but does not overlap with the first common electrode 140c (and/or the first common electrode 140b) in the z direction.

In some embodiments, as shown in FIG. 3, the first common electrodes 140b, 140c have an inverted U shape, but the disclosure is not limited thereto. The shape of the first common electrodes 140b, 140c may include an inverted U shape (as shown in FIG. 4A), a U shape (as shown in FIG. 4B), a rectangular ring shape (as shown in FIG. 4C), an H shape (as shown in FIG. 4D) or other suitable shapes. Although FIG. 3 illustrates that the first common electrodes 140b, 140c have the same shape, it is not intended to limit the disclosure. In other embodiments, the shapes of the first common electrodes 140b, 140c may be different.

In some embodiments, a nearest distance between the first common electrode 140 of each sub-pixel unit (i.e., the first sub-pixel unit PX1, the second sub-pixel unit PX2, and the third sub-pixel unit PX3) in the pixel structure PX and the adjacent data line (e.g., the first data line DL1, the second data line DL2, or the third data line DL3) is not less than a nearest distance between the pixel electrode 120 and the adjacent data line DL. For example, as shown in FIG. 5, a nearest distance d2 between the first common electrode 140b of the second sub-pixel unit PX2 and the second data line DL2 is greater than or equal to a nearest distance d1 between the pixel electrode 120b and the second data line DL2. When the nearest distance d2 is less than the nearest distance d1, power consumption may increase, resulting in energy waste.

In some embodiments, the nearest distances between the first common electrode 140 of each sub-pixel unit (i.e., the first sub-pixel unit PX1, the second sub-pixel unit PX2, and the third sub-pixel unit PX3) in the pixel structure PX and the adjacent data lines (e.g., the first data line DL1, the second data line DL2, or the third data line DL3) are substantially the same as each other.

In some embodiments, the difference between the nearest distance d2 and the nearest distance d1 (i.e., d2-d1) does not exceed 2.5 μm, in order to effectively shield the pixel electrode 120b and/or the auxiliary electrode 130b from the second data line DL2, which may reduce the coupling capacitance between the pixel electrode 120b and the second data line DL2. In some embodiments, the nearest distance d1 may be in the range of 1 μm to 15 μm. It should be understood that although the above content uses the second sub-pixel unit PX2 and the second data line DL2 as an example for explanation, the same principle also applies to the second sub-pixel unit PX2 and the adjacent third data line DL3, the first sub-pixel unit PX1 and the adjacent second data line DL2 and first data line DL1, as well as the third sub-pixel unit PX3 and the adjacent third data line DL3 and first data line DL1.

In summary, the pixel structure of the disclosure includes a first sub-pixel unit, a second sub-pixel unit, and a third sub-pixel unit corresponding to the first region, the second region, and the third region of the display layer of the display device, and the area ratio of the first sub-pixel unit, the second sub-pixel unit, and the third sub-pixel unit is substantially the same as the area ratio of the first region, the second region, and the third region. Therefore, the image quality of the display device may be improved. In addition, the storage capacitance of the first sub-pixel unit, the second sub-pixel unit, and the third sub-pixel unit are substantially the same, which may enhance the display quality of the display device.

Although the disclosure has been described with reference to the embodiments above, the embodiments are not intended to limit the disclosure. Any person skilled in the art can make some changes and modifications without departing from the spirit and scope of the disclosure. Therefore, the scope of the disclosure will be defined in the appended claims.

What is claimed is:

1. A pixel structure, comprising:
a first sub-pixel unit, configured to correspond to a first region of a display layer of a display device, wherein the first region of the display layer has a first display area;
a second sub-pixel unit, configured to correspond to a second region of the display layer, wherein the second region of the display layer has a second display area; and
a third sub-pixel unit, configured to correspond to a third region of the display layer, wherein the third region of the display layer has a third display area,
wherein an area ratio of the first sub-pixel unit, the second sub-pixel unit, and the third sub-pixel unit is substantially the same as an area ratio of the first display area: the second display area:
the third display area.

2. The pixel structure according to claim 1, wherein a storage capacitance of the first sub-pixel unit, a storage capacitance of the second sub-pixel unit, and a storage capacitance of the third sub-pixel unit are substantially the same.

3. The pixel structure according to claim 1, wherein each of the first sub-pixel unit, the second sub-pixel unit, and the third sub-pixel unit comprises:
a pixel electrode;
an auxiliary electrode, electrically connected to the pixel electrode; and
a first common electrode, located between the auxiliary electrode and the pixel electrode.

4. The pixel structure according to claim 3, wherein an area ratio of the pixel electrode of the first sub-pixel unit, the pixel electrode of the second sub-pixel unit, and the pixel electrode of the third sub-pixel unit is substantially the same as an area ratio of the first display area: the second display area: the third display area.

5. The pixel structure according to claim 3, wherein each of the first sub-pixel unit, the second sub-pixel unit, and the third sub-pixel unit further comprises:
a second common electrode, electrically connected to the first common electrode,
wherein in the first sub-pixel unit, a total of an overlap area between the first common electrode and the pixel electrode and an overlap area between the second common electrode and the auxiliary electrode has a first value,
in the second sub-pixel unit, a total of an overlap area between the first common electrode and the pixel electrode and an overlap area between the second common electrode and the auxiliary electrode has a second value,
in the third sub-pixel unit, a total of an overlap area between the first common electrode and the pixel electrode and an overlap area between the second common electrode and the auxiliary electrode has a third value,
wherein the first value, the second value, and the third value are substantially the same.

6. The pixel structure according to claim 3, wherein the first common electrode extends along edges of at least two sides of the pixel electrode.

7. The pixel structure according to claim 3, wherein a shape of the first common electrode comprises a rectangular shape with a notch, an inverted U shape, a U shape, a rectangular ring shape, or an H shape.

8. The pixel structure according to claim 3, wherein the first common electrode of the one with the largest area among the first sub-pixel unit, the second sub-pixel unit, and the third sub-pixel unit does not overlap with the auxiliary electrode.

9. The pixel structure according to claim 3, further comprising:
a first data line, located at one side of the first sub-pixel unit, wherein a nearest distance between the first common electrode of the first sub-pixel unit and the first data line is not less than a nearest distance between the pixel electrode of the first sub-pixel unit and the first data line.

10. The pixel structure according to claim 9, further comprising:
a second data line, located between the first sub-pixel unit and the second sub-pixel unit,
wherein a coupling capacitance between the pixel electrode of the first sub-pixel unit and the first data line, a coupling capacitance between the pixel electrode of the first sub-pixel unit and the second data line, and a coupling capacitance between the pixel electrode of the second sub-pixel unit and the second data line are approximate to each other.
